(19) United States
(12) Patent Application Publication
(10) Pub. No.: US 2013/0076982 A1
(43) Pub. Date: Mar. 28, 2013

(54) TELEVISION SYSTEM AND BOOTING METHOD THEREOF

(71) Applicants: Yi-Min Bai, Changhua County (TW); Chin-Sheng Lee, Taoyuan County (TW); Jui-Fu Hsu, Taoyuan County (TW)

(72) Inventors: Yi-Min Bai, Changhua County (TW); Chin-Sheng Lee, Taoyuan County (TW); Jui-Fu Hsu, Taoyuan County (TW)

(73) Assignee: HANNSTAR DISPLAY CORPORATION, New Taipei City (TW)

(21) Appl. No.: 13/287,104

(22) Filed: Nov. 1, 2011

(30) Foreign Application Priority Data
Sep. 27, 2011 (TW) 100134811

(51) Int. Cl. H04N 5/445

(52) U.S. Cl. 348/563; 348/E05.105

(57) ABSTRACT

A television (TV) system and a booting method thereof are provided. In the present invention, by additionally adding a self-setting booting item into an OSD (on-screen display) menu provided by the TV system, a plurality of booting modes related to the TV system is self-defined by a user under the self-setting booting item. Accordingly, the TV system performs a booting procedure in response to the self-defined and selected booting mode. Since the booting mode of the TV system can be self-defined/selected by the user, the modules corresponding to functions that are not need by the user in the TV system can be turned off/disabled, which avails saving power and improving a booting speed of the TV system, and even increasing practicability of the TV system.

### CROSS-REFERENCE TO RELATED APPLICATION

This application claims the priority benefit of Taiwan application serial no. 100134811, filed on Sep. 27, 2011. The entirety of the above-mentioned patent application is hereby incorporated by reference herein and made a part of this specification.

### BACKGROUND OF THE INVENTION

1. Field of the Invention

The invention relates to a television system and a booting method thereof. Particularly, the invention relates to a television system having user self-defined booting modes and a booting method thereof.

2. Description of Related Art

Along with invention of televisions (TVs) and rapid development of mass media, modern people can easily get information through the TVs. Therefore, watching TV has become one of major entertainments of the modern people. Conventionally, a booting mode of the TV is fixed, and once a user starts the TV, all functions supported by the TV are activated. A part of the activated functions are not needed by the user, though modules related to the functions that are not needed by the user in the TV are still activated/enabled, which is of no avail for power saving, and even a booting speed of the TV is influenced.

### SUMMARY OF THE INVENTION

Accordingly, the invention is directed to a television system having user self-defined booting modes and a booting method thereof, by which problems mentioned in the related art are resolved.

An embodiment of the invention provides a booting method of a television (TV) system. In the method, a self-setting booting item is additionally added into an on-screen display (OSD) menu provided by the TV system to facilitate a user self-defining a plurality of booting modes related to the TV system under the self-setting booting item. The TV system performs a booting procedure in response to one of the booting modes.

In an embodiment of the invention, the step of self-defining includes controlling the OSD menu to provide all functions supported by the TV system for the user to select after the user selects the self-setting booting item, so as to self-define the booting modes under the self-setting booting item, where the functions at least include a cable/non-cable TV function, an Internet protocol TV (IPTV) function and a network routing function, and each of the booting modes corresponds to at least one of the functions supported by the TV system.

In an embodiment of the invention, the step of performing the booting procedure includes following steps. The booting mode selected by the user is determined. The TV system performs the booting procedure in response to the booting mode selected by the user, so as to activate all functions corresponding to the booting mode selected by the user.

Another embodiment of the invention provides a TV system including an on-screen display (OSD) menu and a control module. The OSD menu has at least a self-setting booting item to facilitate a user self-defining a plurality of booting modes related to the TV system under the self-setting booting item. The control module is served as an operation core of the TV system, and performs a booting procedure in response to one of the booting modes.

In an embodiment of the invention, the TV system further includes a display module, a sound module, a network module, a tuner module and an input/output (I/O) module. The display module is coupled to and controlled by the control module, and is served as a display interface of the TV system for displaying the OSD menu in response to a call of the user. The sound module is coupled to and controlled by the control module, and is served as a sound output interface of the TV system. The network module is coupled to and controlled by the control module, and is served as a network interface of the TV system. The tuner module is coupled to the control module, and is served as a cable/non-cable channel receiving interface of the TV system. The I/O module is coupled to the control module, and is served as an input/output interface of the TV system.

In an embodiment of the invention, when the control module determines that the user selects the self-setting booting item, the control module controls the OSD menu to provide all functions supported by the TV system for the user to select, so as to self-define the booting modes under the self-setting booting item, where the functions at least include a cable/non-cable TV function, an Internet protocol TV (IPTV) function and a network routing function, and each of the booting modes corresponds to at least one of the functions.

In an embodiment of the invention, the booting modes include a full-function booting mode, and the full-function booting mode corresponds to the cable/non-cable TV function, the IPTV function and the network routing function. In this case, when the control module determines that the user selects the full-function booting mode, the control module performs the booting procedure in response to the full-function booting mode selected by the user, so as to enable the display module, the sound module, the network module, the tuner module and the I/O module, such that the TV system simultaneously activates the cable/non-cable TV function, the IPTV function and the network routing function.

In an embodiment of the invention, the booting modes further include a cable/non-cable TV booting mode, and the cable/non-cable TV booting module corresponds to the cable/non-cable TV function. In this case, when the control module determines that the user selects the cable/non-cable TV booting mode, the control module performs the booting procedure in response to the cable/non-cable TV booting mode selected by the user, so as to enable the display module, the sound module, the tuner module and the I/O module, and disable the network module, such that the TV system only activates the cable/non-cable TV function.

In an embodiment of the invention, the booting modes further include an IPTV booting mode, and the IPTV booting module corresponds to the IPTV function. In this case, when the control module determines that the user selects the IPTV booting mode, the control module performs the booting procedure in response to the IPTV booting mode selected by the user, so as to enable the display module, the sound module, the network module and the I/O module, and disable the tuner module, such that the TV system only activates the IPTV function.

In an embodiment of the invention, the booting modes further include a network routing booting mode, and the network routing booting module corresponds to the network routing function. In this case, when the control module determines that the user selects the network routing booting mode, the control module performs the booting procedure in response to the network routing booting mode selected by the user, so as to enable the network module, and disable the display module, the sound module, the tuner module and the I/O module, such that the TV system only activates the network routing function.

In an embodiment of the invention, the display module is a liquid crystal display (LCD) module or an organic light emitting diode (OLED) display. The network module is a wired/wireless network module, and the I/O module at least includes a digital video interface (DVI), a composite terminal, a high definition multimedia interface (HDMI) and a universal serial bus (USB) interface.

According to the above descriptions, by additionally adding a self-setting booting item into the OSD menu provided by the TV system, a plurality of booting modes related to the TV system is self-defined by the user under the self-setting booting item. Accordingly, the TV system performs a booting procedure in response to the booting mode self-defined and selected by the user. Since the booting mode of the TV system can be self-defined/selected by the user, the modules corresponding to functions that are not need by the user in the TV system can be turned off/disabled, which avails saving power and improving a booting speed of the TV system, and even increasing practicability of the TV system.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a television (TV) system 10 according to an embodiment of the invention.

FIG. 2A is a schematic diagram of a self-setting booting item of an on-screen display (OSD) menu according to an embodiment of the invention.

FIG. 2B is a schematic diagram of functions supported by a TV system that are provided by an OSD menu according to an embodiment of the invention.

FIG. 3 is a schematic diagram of a selection request in an initial period when the TV system 10 enters a turn-on state from a turn-off state according to an embodiment of the invention.

FIG. 4 is a flowchart illustrating a booting method of a TV system according to an embodiment of the invention.

FIG. 5 is a flowchart illustrating a method of self-defining booting modes related to the TV system according to an embodiment of the invention.

FIG. 6 is a flowchart illustrating a method that the TV system performs a booting procedure according to an embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

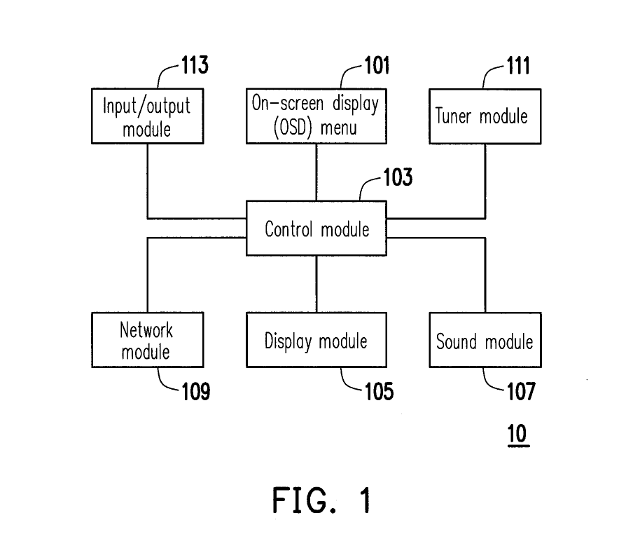

FIG. 1 is a schematic diagram of a television (TV) system 10 according to an embodiment of the invention. Referring to FIG. 1, the TV system 10 includes an on-screen display (OSD) menu 101, a control module 103, a display module 105, a sound module 107, a network module 109, a tuner module 111 and an input/output (I/O) module 113.

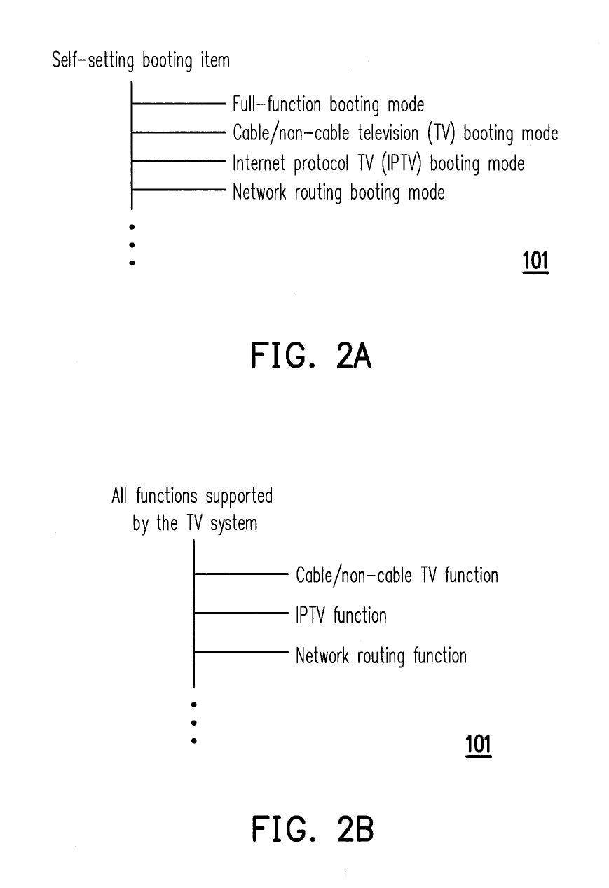

In the present embodiment, the OSD menu 101 at least has a self-setting booting item to facilitate a user self-defining a plurality of booting modes related to the TV system 10 under the self-setting booting item, for example, a full-function booting mode, a cable/non-cable TV booting mode, an Internet protocol TV (IPTV) booting mode and a network routing booting mode, etc., as that shown in FIG. 2A.

The control module 103 is served as an operation core of the TV system 10 (i.e. controls and manages a whole operation of the TV system 10), and performs a booting procedure in response to one of the booting modes related to the TV system 10 that are self-defined by the user under the self-setting booting item.

The display module 105 is coupled to and controlled by the control module 103. The display module 105 is served as a display interface of the TV system 10, and displays the OSD menu 101 in response to a call of the user. In the present embodiment, the display module 105 can be any type of a liquid crystal display (LCD) module or an organic light emitting diode (LED) display.

The sound module 107 is coupled to and controlled by the control module 103, and is served as a sound output interface of the TV system 10. The network module 109 is coupled to and controlled by the control module 103, and is served as a network interface of the TV system 10. In the present embodiment, the network module 109 can be any type of wired/wireless network module, for example, a wired/wireless router or a wired/wireless IP sharer, though the invention is not limited thereto.

The tuner module 111 is coupled to the control module 103, and is served as a cable/non-cable channel receiving interface of the TV system 10. The I/O module 113 is coupled to the control module 103, and is served as an I/O interface of the TV system 10. In the present embodiment, the I/O module 113 at least includes a digital video interface (DVI), a composite terminal, a high definition multimedia interface (HDMI) and a universal serial bus (USB) interface, though the invention is not limited thereto.

According to the descriptions of the related art, it is known that the conventional booting mode of the TV is fixed, and once the user starts the TV, all functions supported by the TV are activated. A part of the activated functions are not needed by the user, though modules related to the functions that are not needed by the user in the TV are still activated/enabled, which is of no avail for power saving, and even a booting speed of the TV is influenced.

Therefore, in the present embodiment, when the control module 103 determines that the user selects the self-setting booting item of the OSD menu 101, the control module 103 controls the OSD menu 101 to provide all functions supported by the TV system 10 (for example, a cable/non-cable TV function, an IPTV function, a network routing function, etc., as that shone in FIG. 2B, though the invention is not limited thereto) for the user to select, so as to self-define the aforementioned full-function booting mode, the cable/non-cable TV booting mode, the IPTV booting mode and the network routing booting mode, etc. under the self-setting booting item of the OSD menu 101, where each of the booting modes corresponds to at least one of the cable/non-cable TV function, the IPTV function and the network routing function, etc.

In detail, the full-function booting mode self-defined by the user under the self-setting booting item of the OSD menu 101 corresponds to all of the functions supported by the TV system 10, i.e. the cable/non-cable TV function, the IPTV function and the network routing function, etc. In this case, when the control module 103 determines that the user selects the full-function booting mode under the self-setting booting item, the control module 103 performs the booting procedure in response to the full-function booting mode selected by the user, so as to enable the display module 105, the sound module 107, the network module 109, the tuner module 111 and the I/O module 113, such that the TV system 10 simultaneously activates the cable/non-cable TV function, the IPTV function and the network routing function, etc. Namely, the TV system 10 is now regarded as a cable/non-cable TV and an IPTV.

Moreover, the cable/non-cable booting mode self-defined by the user under the self-setting booting item of the OSD menu 101 corresponds to the cable/non-cable TV function supported by the TV system 10. In this case, when the control module 103 determines that the user selects the cable/non-cable TV booting mode under the self-setting booting item, the control module 103 performs the booting procedure in response to the cable/non-cable TV booting mode selected by the user, so as to enable the display module 105, the sound module 107, the tuner module 111 and the I/O module 113, and disable the network module 109, such that the TV system 10 only activates the cable/non-cable TV function. Namely, the TV system 10 is now only regarded as a cable/non-cable TV.

Moreover, the IPTV booting mode self-defined by the user under the self-setting booting item of the OSD menu 101 corresponds to the IPTV function supported by the TV system 10. In this case, when the control module 103 determines that the user selects the IPTV booting mode under the self-setting booting item, the control module 103 performs the booting procedure in response to the IPTV booting mode selected by the user, so as to enable the display module 105, the sound module 107, the network module 109 and the I/O module 113, and disable the tuner module 111, such that the TV system 10 only activates the IPTV function. Namely, the TV system 10 is now only regarded as an IPTV.

Besides, the network routing booting mode self-defined by the user under the self-setting booting item of the OSD menu 101 corresponds to the network routing function supported by the TV system 10. In this case, when the control module 103 determines that the user selects the network routing booting mode under the self-setting booting item, the control module 103 performs the booting procedure in response to the network routing booting mode selected by the user, so as to enable the network module 109, and disable the display module 105, the sound module 107, the tuner module 111 and the I/O module 113, such that the TV system 10 only activates the network routing function. Namely, the TV system 10 is now only regarded as a wired/wireless router or a wired/wireless IP sharer.

In other words, as the TV system 10 is in a turn-on state, the user can call the OSD menu 101 for displaying on the display module 105, and selects the self-setting booting item of the OSD menu 101 to self-define (i.e. select from all of the functions supported by the TV system 10) a plurality of booting modes related to the TV system 10, for example, the full-function booting mode, the cable/non-cable TV booting mode, the IPTV booting mode and the network router booting mode, etc.

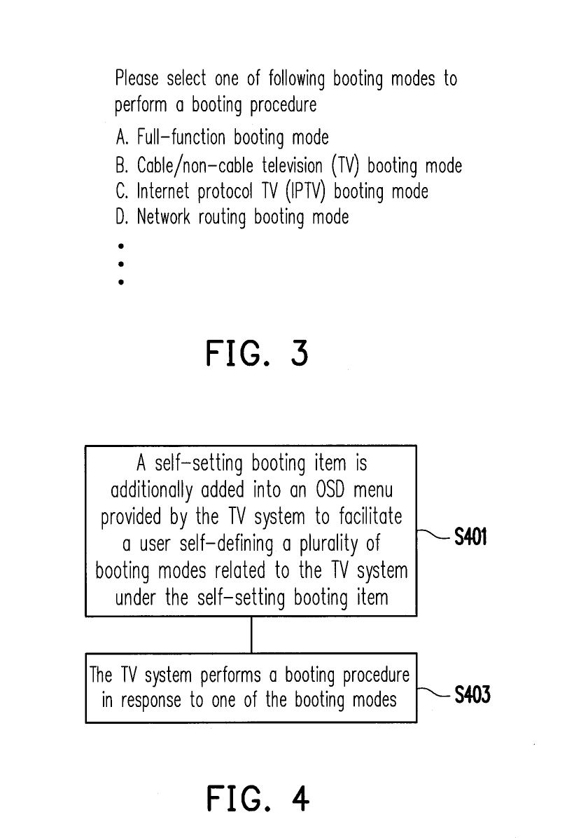

On the other hand, in an initial period when the TV system 10 enters a next turn-on state from a turn-off state, the control module 103 can directly control the display module 105 to display all sub items (i.e. the full-function booting mode, the cable/non-cable TV booting mode, the IPTV booting mode and the network router booting mode, etc.) under the self-setting booting item of the OSD menu 101 for the user to select, as that shown in FIG. 3.

If the user selects the full-function booting mode, the control module 103 enables all of the display module 105, the sound module 107, the network module 109, the tuner module 111 and the I/O module 113, such that the TV system 10 simultaneously activates the cable/non-cable TV function, the IPTV function and the network routing function, etc.

If the user selects the cable/non-cable TV booting mode, the control module 103 enables the display module 105, the sound module 107, the tuner module 111 and the I/O module 113, and disables the network module 109, such that the TV system 10 only activates the cable/non-cable TV function.

If the user selects the IPTV booting mode, the control module 103 enables the display module 105, the sound module 107, the network module 109 and the I/O module 113, and disables the tuner module 111, such that the TV system 10 only activates the IPTV function.

If the user selects the network routing booting mode, the control module 103 enables the network module 109, and disables the display module 105, the sound module 107, the tuner module 111 and the I/O module 113, such that the TV system 10 only activates the network routing function.

Therefore, as the user can self-define/select the booting mode of the TV system 10, the modules related to the functions that are not needed by the user in the TV system 10 can be turned off/disabled, which avails saving power and improving a booting speed of the TV system 10.

Certainly, although the full-function booting mode, the cable/non-cable TV booting mode, the IPTV booting mode, the network routing booting mode are used for descriptions in the above embodiment, in other embodiment of the invention, the user can also self-define booting modes other than the above four booting modes under the self-setting booting item according to an actual usage requirement, and such variation is still considered to be within a protection range of the invention.

According to disclosures/instructions of the above embodiments, FIG. 4 is a flowchart illustrating a booting method of a TV system according to an embodiment of the invention. Referring to FIG. 4, the booting method of the TV system of the present embodiment includes following steps.

A self-setting booting item is additionally added into an OSD menu provided by the TV system to facilitate a user self-defining a plurality of booting modes related to the TV system under the self-setting booting item (step S401).

The TV system performs a booting procedure in response to one of the booting modes (step S403).

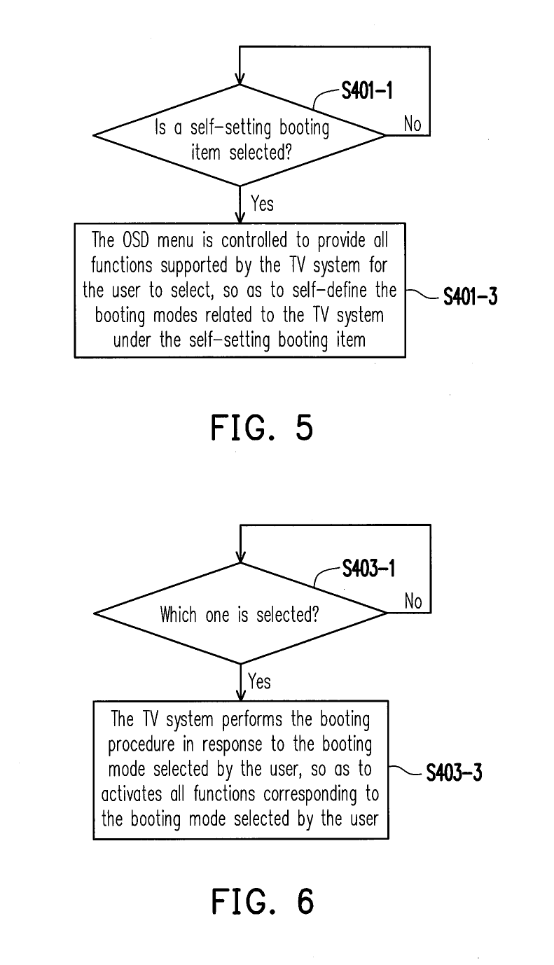

In the present embodiment, as shown in FIG. 5, the step of self-defining includes following steps.

It is determined whether the user selects the self-setting booting item (step S401-1).

If it is determined that the user does not select the self-setting booting item, the step S401-1 is returned.

If it is determined that the user selects the self-setting booting item, the OSD menu is controlled to provide all functions supported by the TV system for the user to select, so as to self-define the booting modes related to the TV system under the self-setting booting item (step S401-3), where the functions at least include a cable/non-cable TV function, an IPTV function and a network routing function, and each of the booting modes corresponds to at least one of the functions.

On the other hand, as shown in FIG. 6, the step of performing the booting procedure includes following steps.

It is determined one of the booting modes related to the TV system that is selected by the user (step S403-1).

If it is determined that the user does not select any one of the booting modes, the step S403-1 is returned.

If it is determined that the user selects one of the booting mode, the TV system performs the booting procedure in response to the booting mode selected by the user, so as to activate all functions corresponding to the booting mode selected by the user (step S403-3).

In summary, by additionally adding a self-setting booting item into the OSD menu provided by the TV system, a plurality of booting modes related to the TV system is self-defined by the user under the self-setting booting item. Accordingly, the TV system performs a booting procedure in response to the booting mode self-defined and selected by the user. Since the booting mode of the TV system can be self-defined/selected by the user, the modules corresponding to functions that are not need by the user in the TV system can be turned off/disabled, which avails saving power and improving a booting speed of the TV system, and even increasing practicability of the TV system.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A booting method of a television (TV) system, comprising:
additionally adding a self-setting booting item into an on-screen display (OSD) menu provided by the TV system to facilitate a user self-defining a plurality of booting modes related to the TV system under the self-setting booting item; and
making the TV system to perform a booting procedure in response to one of the booting modes.

2. The booting method of the TV system as claimed in claim 1, wherein the step of self-defining comprises:
controlling the OSD menu to provide all functions supported by the TV system for the user to select after the user selects the self-setting booting item, so as to self-define the booting modes under the self-setting booting item, wherein each of the booting modes corresponds to at least one of the functions.

3. The booting method of the TV system as claimed in claim 2, wherein the functions at least comprises:
a cable/non-cable TV function;
an Internet protocol TV (IPTV) function; and
a network routing function.

4. The booting method of the TV system as claimed in claim 3, wherein the step of performing the booting procedure comprises:
determining the booting mode that is selected by the user; and
making the TV system to perform the booting procedure in response to the booting mode selected by the user, so as to activate all functions corresponding to the booting mode selected by the user.

5. A television (TV) system, comprising:
an on-screen display (OSD), having at least a self-setting booting item to facilitate a user self-defining a plurality of booting modes related to the TV system under the self-setting booting item; and
a control module, for being served as an operation core of the TV system, and performing a booting procedure in response to one of the booting modes.

6. The TV system as claimed in claim 5, further comprising:
a display module, coupled to and controlled by the control module, for being served as a display interface of the TV system, and displaying the OSD menu in response to a call of the user;
a sound module, coupled to and controlled by the control module, for being served as a sound output interface of the TV system;
a network module, coupled to and controlled by the control module, for being served as a network interface of the TV system;
a tuner module, coupled to the control module, for being served as a cable/non-cable channel receiving interface of the TV system; and
an input/output (1/0) module, coupled to the control module, for being served as an input/output interface of the TV system.

7. The TV system as claimed in claim 6, wherein when the control module determines that the user selects the self-setting booting item, the control module controls the OSD menu to provide all functions supported by the TV system for the user to select, so as to self-define the booting modes under the self-setting booting item, wherein each of the booting modes corresponds to at least one of the functions.

8. The TV system as claimed in claim 7, wherein the functions at least comprises:
a cable/non-cable TV function;
an Internet protocol TV (IPTV) function; and
a network routing function.

9. The TV system as claimed in claim 8, wherein the booting modes comprise a full-function booting mode, and the full-function booting mode corresponds to the cable/non-cable TV function, the IPTV function and the network routing function.

10. The TV system as claimed in claim 9, wherein when the control module determines that the user selects the full-function booting mode, the control module performs the booting procedure in response to the full-function booting mode selected by the user, so as to enable the display module, the sound module, the network module, the tuner module and the I/O module, such that the TV system simultaneously activates the cable/non-cable TV function, the IPTV function and the network routing function.

11. The TV system as claimed in claim 9, wherein the booting modes further comprise a cable/non-cable TV booting mode, and the cable/non-cable TV booting module corresponds to the cable/non-cable TV function.

12. The TV system as claimed in claim 11, wherein when the control module determines that the user selects the cable/non-cable TV booting mode, the control module performs the booting procedure in response to the cable/non-cable TV booting mode selected by the user, so as to enable the display module, the sound module, the tuner module and the I/O module, and disable the network module, such that the TV system only activates the cable/non-cable TV function.

13. The TV system as claimed in claim 11, wherein the booting modes further comprise an IPTV booting mode, and the IPTV booting module corresponds to the IPTV function.

14. The TV system as claimed in claim 13, wherein when the control module determines that the user selects the IPTV booting mode, the control module performs the booting procedure in response to the IPTV booting mode selected by the user, so as to enable the display module, the sound module, the network module and the I/O module, and disable the tuner module, such that the TV system only activates the IPTV function.

15. The TV system as claimed in claim 13, wherein the booting modes further comprise a network routing booting mode, and the network routing booting module corresponds to the network routing function.

16. The TV system as claimed in claim 15, wherein when the control module determines that the user selects the network routing booting mode, the control module performs the booting procedure in response to the network routing booting mode selected by the user, so as to enable the network module, and disable the display module, the sound module, the tuner module and the I/O module, such that the TV system only activates the network routing function.

17. The TV system as claimed in claim 6, wherein the display module is a liquid crystal display (LCD) module.

18. The TV system as claimed in claim 6, wherein the display module is an organic light emitting diode (OLED) display.

19. The TV system as claimed in claim 6, wherein the network module is a wired/wireless network module.

20. The TV system as claimed in claim 19, wherein the wired/wireless network module is a wired/wireless router.

21. The TV system as claimed in claim 19, wherein the wired/wireless network module is a wired/wireless IP sharer.

22. The TV system as claimed in claim 6, wherein the I/O module comprises a digital video interface (DVI).

23. The TV system as claimed in claim 22, wherein the I/O module further comprises a composite terminal.

24. The TV system as claimed in claim 23, wherein the I/O module further comprises a high definition multimedia interface (HDMI).

25. The TV system as claimed in claim 24, wherein the I/O module further comprises a universal serial bus (USB) interface.
